(19) United States
(12) Patent Application Publication
(10) Pub. No.: US 2023/0354874 A1
(43) Pub. Date: Nov. 9, 2023

(54) STUFFING FOOD FORMING APPARATUS AND SYSTEM THEREOF

(71) Applicant: ANKO FOOD MACHINE CO., LTD., New Taipei City (TW)

(72) Inventors: Chin Wei YU, New Taipei City (TW); Chung Ming CHANG, New Taipei City (TW)

(21) Appl. No.: 17/857,006

(22) Filed: Jul. 3, 2022

(30) Foreign Application Priority Data
May 6, 2022 (TW) 111204697

(51) Int. Cl. A23P 20/25; A23P 30/10

(52) U.S. Cl. CPC A23P 20/25; A23P 30/10

(57) ABSTRACT

The present utility invention provides a food forming apparatus, which comprises a mold frame and a clamping mold. The mold frame comprises a first pivot point and two second pivot points. The clamping mold comprises a first mold and a second mold. The present utility invention utilizes a mold frame and a clamping mold which is capable to be pivotably rotatable at different positions, to solve the technical issue during automation.

### FIELD OF THE INVENTION

The present invention relates to a stuffing food forming apparatus and a system thereof, and more particularly, applied in food processing machinery, to solve the technical issue that the stuffing food forming mechanism still needs manual removal.

### BACKGROUND OF THE INVENTION

Please refer to FIGS. 1A-1C, which are diagrams depicting the operation of the stuffing food forming apparatus 100 of the prior art. The apparatus comprises a clamping mold 110 and a pivot point 115. The clamping mold 110 comprises a first mold 111 and a second mold 112. First, in FIG. 1A, a wrapping sheet 113 (such as spring roll skin) and a stuffing 114 are sequentially placed on the clamping mold 110; then, in FIG. 1B, the first mold 111 and the second mold 112 are oppositely pivoted (the “oppositely” here means that the two molds are pivoted in opposite directions, one clockwise and the other counterclockwise), thus the wrapping sheet is closed to form a stuffing food 150; finally, in FIG. 1C, the first mold 111 and the second mold 112 are respectively pivoted and opened in the opposite direction to the mold clamping. The stuffing food 150 stays on the first mold 111 or the second mold 112, and then is removed manually, so that complete automation cannot be achieved.

In view of the reciprocating type of the prior art (the mechanism will return to the initial state in the opposite motion), in the prior art, first, the first mold 111 and the second mold 112 are pivoted upward with the central pivot shaft 115 for mold clamping to form the stuffing food 150; then, the first mold 111 and the second mold 112 are pivoted downward with the central pivot shaft 115 for mold unclamping (returning to the initial horizontal state leaves the stuffing food 150 on the first mold 111 or the second mold 112). Therefore, how to improve the automation level on the basis of the reciprocating mechanism is an urgent problem to be solved.

Thus, there is a need to provide a stuffing food forming apparatus and a system thereof to solve the foregoing technical issue of the prior art.

### SUMMARY OF THE INVENTION

In order to solve the foregoing problems of the prior art, the present invention holds the advantages of the reciprocating mechanism and utilizes a mold frame and a clamping mold which is capable to be pivoted at different positions, to solve the technical issue during automation of the stuffing food.

An objective of the present invention is to provide a stuffing food forming apparatus, comprising a mold frame, a clamping mold, a first driver and at least one second driver. The mold frame comprises a first pivot point and two second pivot points. The clamping mold comprises a first mold and a second mold. The first mold and the second mold are respectively connected to the first pivot point and employed to carry the wrapping sheet. The first driver is employed to drive the first mold to pivot in a first direction with the first pivot point and the second mold to pivot in a second direction with the first pivot point, so that wrapping sheet is subjected to a first clamping operation to be closed to form a stuffing food. The at least one second driver is employed to drive the first mold to pivot in the first direction with the at least one second pivot point and/or the second mold to pivot in the second direction with the at least one second pivot point to perform a second unclamping operation.

In a preferred embodiment, the first driver drives the first pivot point to move linearly in a third direction to drive the first mold and the second mold to perform the first clamping operation.

In a preferred embodiment, when the stuffing food is released from the clamping mold, the first driver drives the first mold to pivot in the second direction with the first pivot point and the second mold to pivot in the first direction with the first pivot point, so that the first mold and the second mold perform a first unclamping operation.

In a preferred embodiment, the stuffing food forming apparatus further comprises at least one demolding component, comprising at least one ejector, wherein when the first mold is pivoted in the first direction with the at least one second pivot point and/or when the second mold is pivoted in the second direction with the at least one second pivot point, the ejector contacts the stuffing food and protrudes a certain distance from a plane of the first mold and/or the second mold, to push the stuffing food away from the first mold or the second mold.

In a preferred embodiment, the at least one demolding component further comprises: an elastic member and an adjuster. The elastic member keeps the ejector from contacting a plane of the wrapping sheet from the first mold and the second mold when the first mold is not pivoted in the first direction with the at least one second pivot point and/or the second mold is not pivoted in the second direction with the at least one second pivot point to perform the second unclamping operation. The adjuster is employed to adjust the certain distance.

In order to solve the problem of the aforesaid prior art, another objective of the present invention further provides a stuffing food forming system, comprising a conveying unit, a stuffing food forming apparatus, a stuffing filling unit and a finished product conveying unit. The conveying unit is employed to convey a wrapping sheet. The stuffing food forming apparatus comprises a mold frame, a clamping mold, a first driver and at least one second driver. The mold frame comprises a first pivot point and two second pivot points. The clamping mold comprises a first mold and a second mold. The first mold and the second mold are respectively connected to the first pivot point and employed to carry the wrapping sheet. The first driver is employed to drive the first mold to pivot in a first direction with the first pivot point and the second mold to pivot in a second direction with the first pivot point, so that wrapping sheet is subjected to a first clamping operation to be closed to form a stuffing food. The at least one second driver is employed to drive the first mold to pivot in the first direction with the at least one second pivot point and/or the second mold to pivot in the second direction with the at least one second pivot point to perform a second unclamping operation. The stuffing filling unit is employed to fill a stuffing on the wrapping sheet. The finished product conveying unit is arranged below the stuffing food forming apparatus and employed to receive the stuffing food released from the clamping mold.

In a preferred embodiment, the first driver drives the first pivot point to move linearly in a third direction to drive the first mold and the second mold to perform the first clamping operation.

In a preferred embodiment, when the stuffing food is released from the clamping mold, the first driver drives the first mold to pivot in the second direction with the first pivot point and the second mold to pivot in the first direction with the first pivot point, so that the first mold and the second mold perform a first unclamping operation.

In a preferred embodiment, the stuffing food forming apparatus further comprises at least one demolding component, comprising at least one ejector, wherein when the first mold is pivoted in the first direction with the at least one second pivot point and/or when the second mold is pivoted in the second direction with the at least one second pivot point, the ejector contacts the stuffing food and protrudes a certain distance from a plane of the first mold and/or the second mold, to push the stuffing food away from the first mold or the second mold.

In a preferred embodiment, the at least one demolding component further comprises: an elastic member and an adjuster. The elastic member keeps the ejector from contacting a plane of the wrapping sheet from the first mold and the second mold when the first mold is not pivoted in the first direction with the at least one second pivot point and/or the second mold is not pivoted in the second direction with the at least one second pivot point to perform the second unclamping operation. The adjuster is employed to adjust the certain distance.

Compared with the prior art, the present invention holds the advantages of the reciprocating mechanism and utilizes a mold frame and a clamping mold which is capable to be pivoted at different positions, to solve the technical issue during automation of the stuffing food.

### BRIEF DESCRIPTION OF THE DRAWINGS

FIGS. 1A-1C are diagrams depicting the operation of the stuffing food forming apparatus 100 of the prior art;

FIG. 2 depicts a diagram of an entire machine comprising the stuffing food forming system 10 according to the present invention;

FIG. 3 depicts an exploded perspective diagram of the stuffing food forming apparatus of the present invention according to FIG. 2;

FIG. 4 depicts a partially exploded perspective diagram of the stuffing food forming apparatus of the present invention according to FIG. 3;

FIGS. 5A-5C are diagrams depicting the clamping operation of the stuffing food forming apparatus of the present invention; and

FIGS. 6A-6B are diagrams depicting the unclamping operation of the stuffing food forming apparatus of the present invention.

### DETAILED DESCRIPTION OF PREFERRED EMBODIMENTS

The following descriptions of the embodiments refer to the appended figures to illustrate specific embodiments in which the present invention may be implemented. The directional terms of up, down, front, rear, left, right, interior, exterior, side, etcetera mentioned in the present invention are merely directions of referring to appended figures. Therefore, the aforesaid directional terms are employed for explaining and understanding the present invention, but the present invention is not limited thereto.

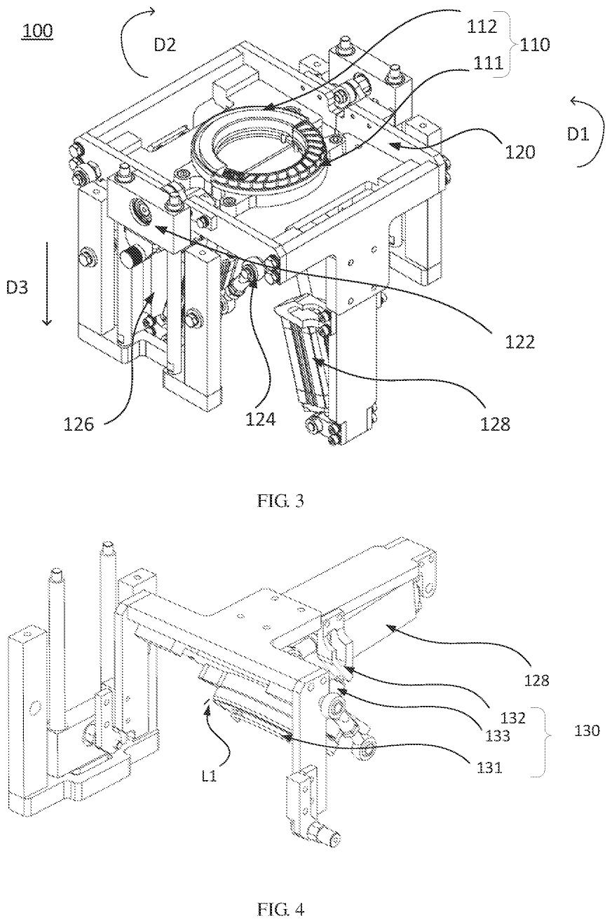

Please refer to FIGS. 2-4. FIG. 2 depicts a diagram of an entire machine comprising the stuffing food forming system 10 according to the present invention; FIG. 3 depicts an exploded perspective diagram of the stuffing food forming apparatus 100 of the present invention according to FIG. 2; FIG. 4 depicts a partially exploded perspective diagram of the stuffing food forming apparatus 100 of the present invention according to FIG. 3. The stuffing food forming system 10 comprises a conveying unit 210, a stuffing food forming apparatus 100, a stuffing filling unit 220 and a finished product conveying unit 230. The conveying unit 210 is employed to convey a wrapping sheet 113.

The stuffing food forming apparatus 100 comprises a mold frame 120, a clamping mold 110, a first driver 126 and at least one second driver 128. The mold frame 120 comprises a first pivot point 122 and two second pivot points 124. The clamping mold 110 comprises a first mold 111 and a second mold 112. The first mold 111 and the second mold 112 are respectively connected to the first pivot point 122 and employed to carry the wrapping sheet 113. Specifically, only one of the second drivers 128 is marked in the figures. In this preferred embodiment, two second drivers 128 are practically employed to respectively drive the first mold 111 and the second mold 112.

Specifically, in this preferred embodiment, each of the second drivers 128 can only drive the first mold 111 or the second mold 112. However, it is not limited that the two second drivers 128 in this preferred embodiment can adopt another driver as a driving source.

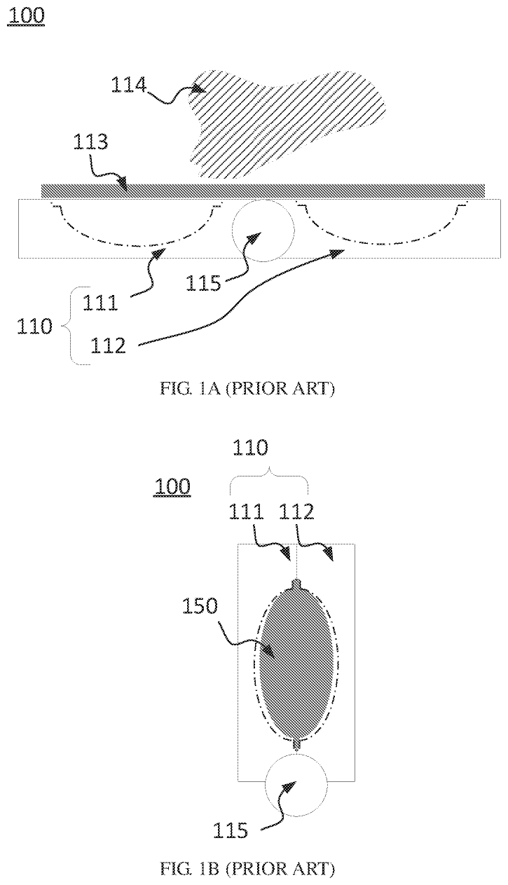

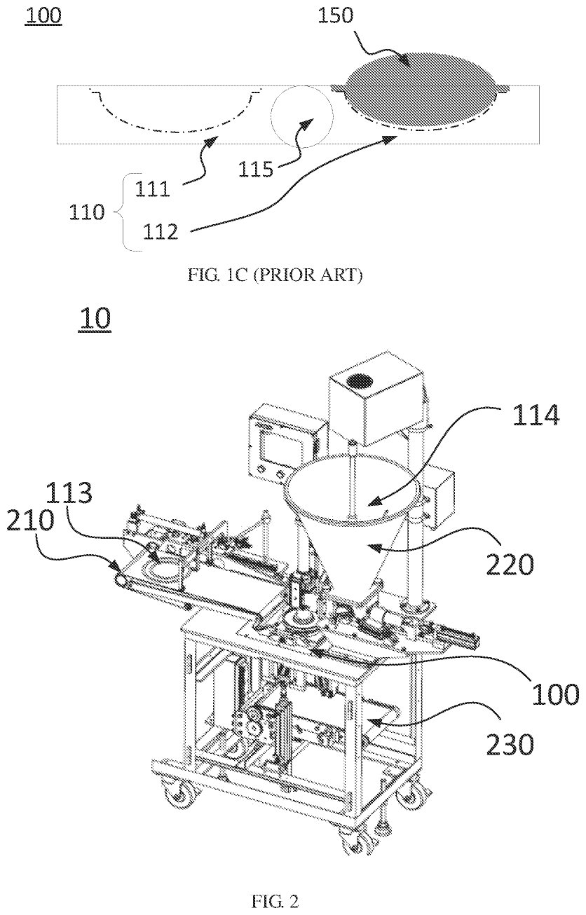

The first driver 126 is employed to drive the first mold 111 to pivot in a first direction D1 with the first pivot point 122 and the second mold 112 to pivot in a second direction D2 with the first pivot point 122, so that wrapping sheet 113 is subjected to a first clamping operation to be closed to form a stuffing food (not shown, please refer to the stuffing food 150 in FIG. 1B). In detail, in the present invention, the first mold 111 and the second mold 112 are both pivoted to accomplish the first clamping operation; however, it is also possible to pivot only the first mold 111 or the second mold 112, which is not limited thereto.

The two second drivers 128 are respectively employed to drive the first mold 111 to pivot in the first direction D1 with one second pivot point 124 and the second mold 112 to pivot in the second direction D2 with the other second pivot point 124 to perform a second unclamping operation. In the figures, only the second pivot point 124 corresponding to the first mold 111 is marked, the second pivot point 124 corresponding to the second mold 112 is located at a corresponding position.

In detail, the first pivot point 122 and the two second pivot points 124 are respectively disposed on both sides of the first mold and the second mold (refer to the figure).

Preferably, the first driver 126 and the second driver 128 can be hydraulic or pneumatic drivers but not limited thereto.

In detail, the first clamping operation here refers to the mold clamping operation performed with the first pivot point 122 as the pivot center; the second unclamping operation refers to the mold unclamping operation performed with the second pivot points 122 as the pivot centers. Similarly, the first unclamping operation refers to the mold unclamping operation performed with the first pivot point 122 as the pivot center; the second clamping operation refers to the mold clamping operation performed with the second pivot points 122 as the pivot centers.

After the wrapping sheet 113 is placed on the clamping mold 110, the stuffing filling unit 220 is employed to fill a stuffing 114 on the wrapping sheet 113. Then, the aforesaid forming operation of the stuffing food is implemented. After said operation is accomplished, the finished product conveying unit 230 is arranged below the stuffing food forming apparatus 100 and employed to receive the stuffing food 150 released from the clamping mold 110.

In detail, the first driver 126 drives the first pivot point 122 to move linearly in a third direction D3 to drive the first mold 111 and the second mold 112 to perform the first clamping operation.

Preferably, when the stuffing food 150 is released from the clamping mold 110, the first driver 126 drives the first mold 111 to pivot in the second direction D2 with the first pivot point 122 and the second mold 112 to pivot in the first direction D1 with the first pivot point 122, so that the first mold 111 and the second mold 112 perform a first unclamping operation.

Preferably, the stuffing food forming apparatus further comprises at least one demolding component 130, comprising at least one ejector 131, an elastic member 133 and an adjuster 132. When the first mold 111 is pivoted in the first direction D1 with the second pivot point 124 and/or when the second mold 112 is pivoted in the second direction D2 with the other second pivot point 124, the ejector 131 contacts the stuffing food 150 and protrudes a certain distance L1 from a plane of the first mold 111 and/or the second mold 112, to push the stuffing food 150 away from the first mold 111 or the second mold 112. The elastic member 133 keeps the ejector 131 from contacting the plane of the wrapping sheet 113 from the first mold 111 and the second mold 112 when the first mold 111 is not pivoted in the first direction D1 with the second pivot point 124 and/or the second mold 112 is not pivoted in the second direction D2 with the other second pivot point 124 to perform the second unclamping operation. The adjuster 132 is employed to adjust the certain distance L1. It can be adjusted to a proper distance according to different situations (different ingredients, etc.).

In detail, the ejector 131 can adopt different methods such as when the first mold 111 and/or the second mold 112 are gradually pushed out along with pivoting, and can be adjusted according to the properties of different ingredients.

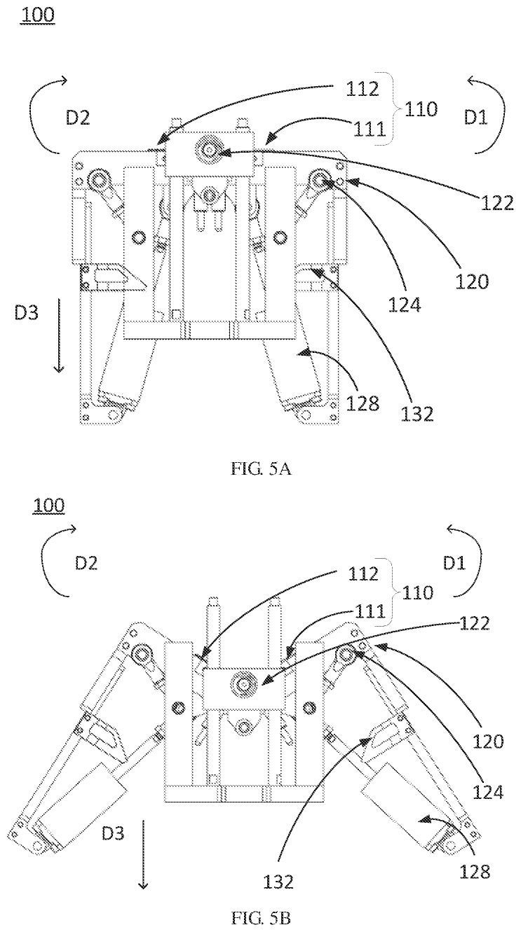

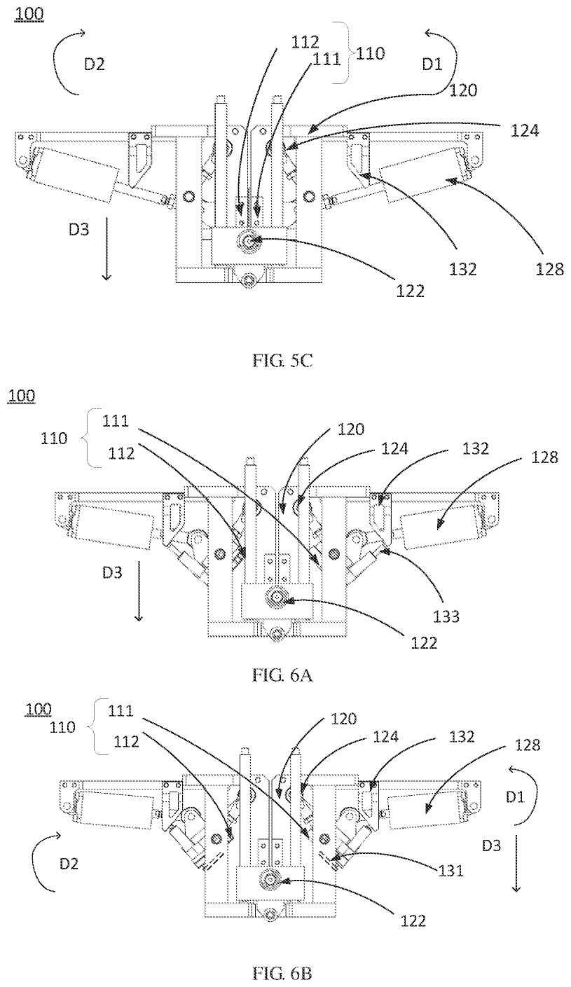

The actual operation process of the stuffing food forming apparatus 100 according to the present invention is as follows. Please refer to FIGS. 5A-5C and FIGS. 6A-6B. FIGS. 5A-5C are diagrams depicting the clamping operation of the stuffing food forming apparatus 100 of the present invention; FIGS. 6A-6B are diagrams depicting the unclamping operation of the stuffing food forming apparatus 100 of the present invention. Please refer to FIG. 2 to FIG. 4 for component symbols, and will not be repeated here. Specifically, in the present invention, the first clamping operation, the second unclamping operation, the second clamping operation and the first unclamping operation are performed in sequence, and then repeated continuously.

In FIG. 5A, the first mold 111 and the second mold 112 are in an open (horizontal) state for placing the wrapping sheet 113 and the stuffing 114. The first mold 111 is pivoted in the first direction D1 with the first pivot point 122 and the second mold 112 is pivoted in the second direction D2 with the first pivot point 122.

In FIG. 5B, the first mold 111 and the second mold 112 are pivoted about 90 degrees. It can be noted that in this preferred embodiment, the first pivot point 122 is moved in the third direction D3 (that is, the lower side in the figure). The parts of the first mold 111 and the second mold 112 away from the first pivot point 122 are gradually approached with the linkage design.

In FIG. 5C, the first clamping operation is accomplished, and the wrapping sheet 113 is closed to form the stuffing food (not shown, please refer to the stuffing food 150 in FIG. 1B).

Then, in FIG. 6A, the first mold 111 is pivoted in the first direction D1 with one second pivot point 124 and the second mold 112 is pivoted in the second direction D2 with the other second pivot point 124 to perform the second unclamping operation. When the elastic member 133 contacts the adjuster 132, the ejector 131 protrudes out of the first mold 111 and/or the second mold 112 to contact that plane of the wrapping sheet 113.

Finally, in FIG. 66, the first mold 111 is pivoted to the end in the first direction D1 with the second pivot point 124 and the second mold 112 is pivoted to the end in the second direction D2 with the other second pivot point 124, thus to push the stuffing food 150 away from the first mold 111 or the second mold 112.

Specifically, in this preferred embodiment, both the first mold 111 and the second mold 112 are pivoted to perform the second unclamping operation. However, only one of them can be pivoted for operation, as long as the space is sufficient for the stuffing food 150 to be released from the clamping mold 110. When it is not certain that the stuffing food will be attached to the first mold 111 or the second mold 112, the demolding component 130 needs to be disposed at both the first mold 111 and the second mold 112. However, under certain conditions, for instance, the first mold 111 (or the second mold 112) is applied with the special non-stick treatment, so that the stuffing food 150 possesses a higher probability of being attached to the second mold 112. Then, the demolding component 130 only needs to be provided at the second mold 112.

Above are only preferred embodiments of the present invention, and it should be noted that to any persons who are skilled in the art, improvement and modification which is easily derived should be covered by the protected scope of the application. Thus, the protected scope of the application should go by the subject claims, including the improvement and the modification.

### ELEMENT NUMBER DESCRIPTION

10: food forming system
100: food shaping apparatus
110: clamping mold
111: first mold
112: second mold
113: wrapping sheet
114: stuffing
115: pivot point
120: mold frame
122: first pivot point
124: second pivot point
126: first driver
128: second driver
130: demolding component
131: ejector
132: adjuster
133: elastic member
150: stuffing food
210: conveying unit
220: stuffing filling unit
230: finished product conveying unit
D1, D2, D3: directions

What is claimed is:

1. A stuffing food forming apparatus, comprising:
a mold frame, comprising a first pivot point and at least one second pivot point;
a clamping mold, comprising a first mold and a second mold, wherein the first mold and the second mold are respectively connected to the first pivot point and employed to carry a wrapping sheet;
a first driver, employed to drive the first mold to pivot in a first direction with the first pivot point and the second mold to pivot in a second direction with the first pivot point, so that wrapping sheet is subjected to a first clamping operation to be closed to form a stuffing food; and
at least one second driver, employed to drive the first mold to pivot in the first direction with the at least one second pivot point and/or the second mold to pivot in the second direction with the at least one second pivot point to perform a second unclamping operation.

2. The stuffing food forming apparatus according to claim 1, wherein the first driver drives the first pivot point to move linearly in a third direction to drive the first mold and the second mold to perform the first clamping operation.

3. The stuffing food forming apparatus according to claim 1, wherein when the stuffing food is released from the clamping mold, the first driver drives the first mold to pivot in the second direction with the first pivot point and the second mold to pivot in the first direction with the first pivot point, so that the first mold and the second mold perform a first unclamping operation.

4. The stuffing food forming apparatus according to claim 1, further comprising at least one demolding component, comprising at least one ejector, wherein when the first mold is pivoted in the first direction with the at least one second pivot point and/or when the second mold is pivoted in the second direction with the at least one second pivot point, the ejector contacts the stuffing food and protrudes a certain distance from a plane of the first mold and/or the second mold, to push the stuffing food away from the first mold or the second mold.

5. The stuffing food forming apparatus according to claim 4, wherein the at least one demolding component further comprises:
an elastic member, keeping the ejector from contacting a plane of the wrapping sheet from the first mold and the second mold when the first mold is not pivoted in the first direction with the at least one second pivot point and/or the second mold is not pivoted in the second direction with the at least one second pivot point to perform the second unclamping operation; and
an adjuster, employed to adjust the certain distance.

6. A stuffing food forming system, comprising:
a conveying unit, employed to convey a wrapping sheet;
a stuffing food forming apparatus, comprising:
a mold frame, comprising a first pivot point and two second pivot points;
a clamping mold, comprising a first mold and a second mold, wherein the first mold and the second mold are respectively connected to the first pivot point and employed to carry the wrapping sheet; and
a first driver, driving the first mold to pivot in a first direction with the first pivot point and the second mold to pivot in a second direction with the first pivot point, so that wrapping sheet is closed in a first direction to form a stuffing food; and
a stuffing filling unit, employed to fill a stuffing on the wrapping sheet; and
a finished product conveying unit, arranged below the stuffing food forming apparatus and employed to receive the stuffing food released from the clamping mold.

7. The stuffing food forming system according to claim 6, wherein the first driver drives the first pivot point to move linearly in a third direction to drive the first mold and the second mold to perform the first clamping operation.

8. The stuffing food forming system according to claim 6, wherein when the stuffing food is released from the clamping mold, the first driver drives the first mold to pivot in the second direction with the first pivot point and the second mold to pivot in the first direction with the first pivot point, so that the first mold and the second mold perform a first unclamping operation.

9. The stuffing food forming system according to claim 6, further comprising at least one demolding component, comprising at least one ejector, wherein when the first mold is pivoted in the first direction with the two second pivot point and/or when the second mold is pivoted in the second direction with the two second pivot point to perform the second unclamping operation, the ejector contacts the stuffing food and protrudes a certain distance from a plane of the first mold and/or the second mold, to push the stuffing food away from the first mold or the second mold.

10. The stuffing food forming system according to claim 9, wherein the at least one demolding component further comprises:
an elastic member, keeping the ejector from contacting a plane of the wrapping sheet from the first mold and the second mold when the first mold is not pivoted in the first direction with the two second pivot point and/or the second mold is not pivoted in the second direction with the two second pivot point to perform the second unclamping operation; and
an adjuster, employed to adjust the certain distance.
